(19) United States
(12) Patent Application Publication
(10) Pub. No.: US 2025/0208485 A1
(43) Pub. Date: Jun. 26, 2025

(54) Locking Mechanism in Variable Aperture Device for Camera

(71) Applicant: Apple Inc., Cupertino, CA (US)

(72) Inventors: Wei Li, Sunnyvale, CA (US); Bin Xu, Sunnyvale, CA (US); Xu Wang, San Jose, CA (US)

(73) Assignee: Apple Inc., Cupertino, CA (US)

(21) Appl. No.: 18/977,778

(22) Filed: Dec. 11, 2024

Related U.S. Application Data
(60) Provisional application No. 63/614,429, filed on Dec. 22, 2023.

(51) Int. Cl. G03B 9/06; H04N 23/55

(52) U.S. Cl. CPC G03B 9/06; H04N 23/55

(57) ABSTRACT

Various embodiments include a locking mechanism in a variable aperture device for a camera system. The variable aperture device may be coupled with a lens assembly of the camera system. The variable aperture device may include aperture blades arranged to form an aperture stop, and an actuator for moving the aperture blades to change the size of the aperture. In various embodiments, the variable aperture device may include a stator and a rotor. According to various embodiments, the locking mechanism may include one or more metal plates coupled with the stator or the rotor. The metal plate(s) may magnetically interact with one or more magnetic components of the actuator to maintain a particular aperture size when no power is supplied to the actuator, according to various embodiments.

### PRIORITY CLAIM

This application claims benefit of priority to U.S. Provisional Application Ser. No. 63/614,429, entitled “Locking Mechanism in Variable Aperture Device for Camera,” filed Dec. 22, 2023, and which is hereby incorporated herein by reference in its entirety.

### TECHNICAL FIELD

This disclosure relates generally to a locking mechanism in a variable aperture device for a camera.

### DESCRIPTION OF THE RELATED ART

The advent of small, mobile multipurpose devices such as smartphones and tablet or pad devices has resulted in a need for high-resolution, small form factor cameras for integration in the devices. Some small form factor cameras may incorporate optical image stabilization (OIS) mechanisms that may sense and react to external excitation/disturbance by adjusting location of the optical lens on the X and/or Y axis in an attempt to compensate for unwanted motion of the lens. Some small form factor cameras may incorporate an autofocus (AF) mechanism whereby the object focal distance can be adjusted to focus an object plane in front of the camera at an image plane to be captured by the image sensor. In some such autofocus mechanisms, the optical lens is moved as a single rigid body along the optical axis of the camera to refocus the camera.

### BRIEF DESCRIPTION OF THE DRAWINGS

FIG. 1 illustrates a schematic side cross-sectional view of an example camera system that may include a variable aperture device, in accordance with some embodiments.

FIGS. 2A-2B illustrate views of an example variable aperture device that may be included in a camera system, in accordance with some embodiments. FIG. 2A shows a perspective view of the variable aperture device in a first state. FIG. 2B shows a perspective view of the variable aperture device in a second state having a different aperture size than the first state.

FIGS. 3A-3D illustrate views of an example variable aperture device that may be included in a camera system, in accordance with some embodiments. FIG. 3A shows an exploded perspective view of the variable aperture device. FIG. 3B shows a collapsed perspective view of the variable aperture device. FIG. 3C shows a perspective view of an example rotor assembly of the variable aperture device. FIG. 3D shows a perspective view of an example stator assembly of the variable aperture device.

FIGS. 4A-4B illustrate views of respective example electromagnetic arrangements that may be used in a voice coil motor (VCM) actuator of a variable aperture device, in accordance with some embodiments. FIG. 4A shows a perspective view of an electromagnetic arrangement that includes a dual-pole magnet in a magnet-coil group with a single coil. FIG. 4B shows a perspective view of an electromagnetic arrangement that includes a single-pole magnet in a magnet-coil group with multiple coils.

FIG. 5 illustrates a perspective view of an example wound coil that may be used in a voice coil motor (VCM) actuator of a variable aperture device, in accordance with some embodiments.

FIGS. 6A-6C illustrate views of an example variable aperture device that may be included in a camera system and that may include a locking mechanism, in accordance with some embodiments. FIG. 6A shows a schematic top view of the variable aperture device in an example locked position. FIG. 6B shows a schematic top view of the variable aperture device in a first example unlocked position. FIG. 6C shows a schematic top view of the variable aperture device in a second example unlocked position. According to various embodiments, the variable aperture device may include a voice coil motor (VCM) actuator having magnets attached to a rotor, and coils attached to a stator.

FIGS. 7A-7C illustrate views of an example variable aperture device that may be included in a camera system and that may include a locking mechanism, in accordance with some embodiments. FIG. 7A shows a schematic top view of the variable aperture device in an example locked position. FIG. 7B shows a schematic top view of the variable aperture device in a first example unlocked position. FIG. 7C shows a schematic top view of the variable aperture device in a second example unlocked position. According to various embodiments, the variable aperture device may include a voice coil motor (VCM) actuator having magnets attached to a rotor, and coils attached to a stator.

FIGS. 8A-8C illustrate views of an example variable aperture device that may be included in a camera system and that may include a locking mechanism, in accordance with some embodiments. FIG. 8A shows a schematic top view of the variable aperture device in an example locked position. FIG. 8B shows a schematic top view of the variable aperture device in a first example unlocked position. FIG. 8C shows a schematic top view of the variable aperture device in a second example unlocked position. According to various embodiments, the variable aperture device may include a voice coil motor (VCM) actuator having coils attached to a rotor, and magnets attached to a stator.

FIG. 9 illustrates a perspective view of an example temperature sensing arrangement that may be included in a variable aperture device, in accordance with some embodiments.

FIG. 10 is a flowchart that illustrates an example method of controlling an aperture size of a variable aperture device based at least in part on temperature data from a temperature sensor of the variable aperture device, in accordance with some embodiments.

FIG. 11 is a flowchart that illustrates an example method of controlling a focus position based at least in part on temperature data from a temperature sensor of a variable aperture device, in accordance with some embodiments.

FIG. 12 is a flowchart that illustrates an example method of controlling an aperture size of a variable aperture device that includes a locking mechanism, in accordance with some embodiments.

FIG. 13 illustrates a schematic representation of an example environment comprising a device that may include a camera with a variable aperture device, in accordance with some embodiments.

FIG. 14 illustrates a schematic block diagram of an example environment comprising a computer system that may include a camera with a variable aperture device, in accordance with some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units.” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112 (f) for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### DETAILED DESCRIPTION

Various embodiments include a variable aperture device for a camera system. The variable aperture device may be coupled with a lens assembly of the camera system. The lens assembly may include a lens group contained within a lens barrel. In various embodiments, the variable aperture device may sit atop a portion of the lens assembly. Aspects of the variable aperture device described herein solve problems that may exist in other camera systems, such as problems pertaining to camera/device size, weight, and/or performance, as will be discussed in further detail throughout this disclosure.

According to various embodiments, the variable aperture device may be configured to provide a variable aperture for the lens group and/or the camera system. The variable aperture device may include a stator, a rotor, aperture blades, and an actuator. The aperture blades may be arranged to form an aperture stop. The actuator may be used for moving the aperture blades to change the size of the aperture within a range of aperture sizes. The aperture stop may function to limit the amount of light that reaches the lens group via the aperture.

In various embodiments, the stator may include a base portion, a central portion, and an outer protrusion portion. The central portion may extend, in a first direction parallel to an optical axis of the camera system, from an upper surface of the base portion. In some embodiments, the central portion may be cylindrically shaped, with a through hole centrally located so that light can pass through the variable aperture device to the lens group. The outer protrusion portion may comprise protrusions that extend, in the first direction, from the upper surface of the base portion. The upper surface of the base portion may extend, in a second direction orthogonal to the optical axis, between the central portion and the outer protrusion portion. The protrusions may be distributed in a pattern that at least partially encircles the central portion. According to various embodiments, the rotor may include a rotor wall that encircles the central portion of the stator. The rotor wall may be positioned, in the second direction orthogonal to the optical axis, between the central portion and the outer protrusion portion of the stator.

In various embodiments, the actuator may be configured to rotate the rotor, relative to the stator, about an axis that is parallel to the optical axis. The actuator may include a first portion fixedly coupled with the rotor wall, and a second portion fixedly coupled with the outer protrusion portion of the stator. The aperture blades may be coupled with the stator and the rotor. Rotation of the rotor may cause the aperture blades to move so as to change the size of the aperture.

In some embodiments, the actuator may include a voice coil motor (VCM) actuator having one or more magnets and one or more coils. The coil(s) may be positioned proximate the magnet(s) such that, when driven with an electric current, the coil(s) are capable of electromagnetically interacting with the magnet(s) to produce Lorentz forces that rotate the rotor about the axis parallel to the optical axis. In some embodiments, the magnet(s) may be fixedly coupled with the rotor wall, and the coil(s) may be fixedly coupled with the outer protrusion portion of the stator. In other embodiments, the coil(s) may be fixedly coupled with the rotor wall, and the magnet(s) may be fixedly coupled with the outer protrusion portion of the stator.

As compared with some other systems, the configuration of the VCM, the rotor, and the stator disclosed herein may enable a reduction in thermal impact of a heat source (e.g., the coil(s)) on the optics. In various embodiments, the central portion of the stator may provide an additional heat barrier between the coil(s) and the lens group, relative to other systems that lack such a heat barrier.

In various embodiments, the variable aperture device may include a flex circuit and one or more temperature sensors. The flex circuit may be coupled with the stator. The temperature sensor(s) may be coupled with the flex circuit and positioned proximate the lens group. In various embodiments, the flex circuit may be a single-piece flex circuit that is attached to the base portion of the stator. As compared with some other systems that may include multiple flex circuits (instead of a single-piece flex circuit), using the single-piece flex circuit as described herein may enable a reduction in size (and/or weight) of the variable aperture device and/or the camera system. Furthermore, placing the temperature sensor(s) near the lens group may solve problem(s) of how to increase accuracy with respect to position sensor calibration and/or with respect to determining paraxial focal length (PFL) error. Some other systems may require inferring lens temperature based on a temperature sensor at a different location that is not on the variable aperture device and/or that is further away from the lens than the temperature sensor(s) disclosed herein.

In some embodiments, the increased accuracy in determining PFL error enabled by the temperature sensor(s) located on the flex circuit near the lens group may allow for an improvement with respect to determining when to switch from using a first camera of a camera system to a second camera of the camera system as the distance to an object changes. As a non-limiting example, other systems with less accurate PFL error determination capabilities may switch from using a wide camera to an ultra-wide camera, as the camera system approaches the object, at an earlier time than ideal, based on a lower confidence in the wide camera's ability to handle the object distance. With the greater accuracy (and hence confidence) enabled by the temperature sensing arrangement disclosed herein, image quality may be improved by optimizing use of different cameras in a camera system.

According to various embodiments, the variable aperture device may include an aluminum shield can that at least partially encases the variable aperture device. For example, the aluminum shield can may at least partially encase the VCM actuator. Using aluminum to form the shield can provides a solution to the problems of how to reduce the size and weight of the variable aperture device and/or the camera system. As compared with systems that use a different material (e.g., copper) for the shield can, the aluminum shield can may be formed to be thinner and may have a lower density, which enable a reduction in size (e.g., in the X-Y footprint of the variable aperture device and/or the camera system) and/or a reduction in weight.

In some embodiments, the aluminum shield can and the aperture blades may be coated with a black material that reduces the reflectivity of the aluminum shield can and the aperture blades. In some examples, the material used to coat the aluminum shield can and/or the aperture blades may be a “super-black” or an “ultra-black” coating that offer a greater reduction in reflectivity than materials used in some other systems.

In some embodiments, the aperture blades may be designed so that they form a circular aperture at a particular aperture size. The circular aperture may be a close approximation of a circular shape, e.g., approaching the shape of a circle rather than a polygon. As compared with variable aperture designs of some other systems, the circular aperture may be closer to a circular shape and those other systems may have apertures having shapes that appear more polygonal (e.g., hexagonal) than circular across the entire range of aperture sizes.

In some non-limiting embodiments, the particular aperture size at which the aperture blades are designed to form a circular shape may be an aperture size that is between the largest aperture size and the smallest aperture size within the range of aperture sizes that the variable aperture device is capable of forming. For example, the particular aperture size at which the aperture blades are optimized to form a circular shape may be a middle/intermediate aperture size within the range of aperture sizes in some embodiments.

Various parameters may be optimized to achieve this objective. For example, such parameters may include shape and/or size of the aperture blades, coupling slots defined by the aperture blades, and/or coupling pin holes defined by the aperture blades, as well as the geometry of the stator, the rotor, pins on the stator and the rotor with which the aperture blades may be coupled (e.g., via the coupling slots and the coupling pin holes), etc. In various embodiments, the aperture blades may be shaped to have an inner edge with a curvature, e.g., as indicated in various figures of this disclosure.

Designing the aperture blades so that they form a circular aperture at a particular aperture size solves problem(s) of how to reduce unintended flare, aberrations, and/or diffraction, etc., in images captured using the camera system. Thus, the aperture blade design in the variable aperture device disclosed herein may enable various improvements in optical performance and/or image quality.

According to various embodiments, the variable aperture device may include a locking mechanism comprising one or more metal plates fixedly coupled with the stator or the rotor. The locking mechanism may be used to maintain the variable aperture device at a particular aperture size when no power is supplied to the actuator.

In some embodiments, the variable aperture device and/or the camera system may be operable such that when no power is supplied to the actuator, an attractive force between one or more magnetic components of the actuator (e.g., one or more magnets of the VCM actuator) and the metal plate(s) is sufficient to maintain a predetermined aperture size by resisting rotation of the rotor, relative to the stator, about the axis parallel to the optical axis. The locking mechanism may provide resistance to external shock vibration, reduce risk of damage to the lens group, and/or reduce risk of bending the aperture blades when no power is supplied to the actuator. Furthermore, the variable aperture device and/or the camera system may be operable such that, when a threshold amount of power is supplied to the actuator, a rotational force produced by the actuator is sufficient to overcome the attractive force between the magnetic component(s) and the metal plate(s), so as to rotate the rotor, relative to the stator, about the axis, to change the aperture size.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that some embodiments may be practiced without these specific details. In other instances, well-known methods, procedures, components, circuits, and networks have not been described in detail so as not to unnecessarily obscure aspects of the embodiments.

FIG. 1 illustrates a schematic side cross-sectional view of an example camera system 100 that may include a variable aperture device 102 and/or a lens assembly 104, in accordance with some embodiments. According to various embodiments, the variable aperture device 102 may be coupled with the lens assembly 104. For example, as indicated in FIG. 1, the variable aperture device 102 may generally sit atop a portion of the lens assembly 104.

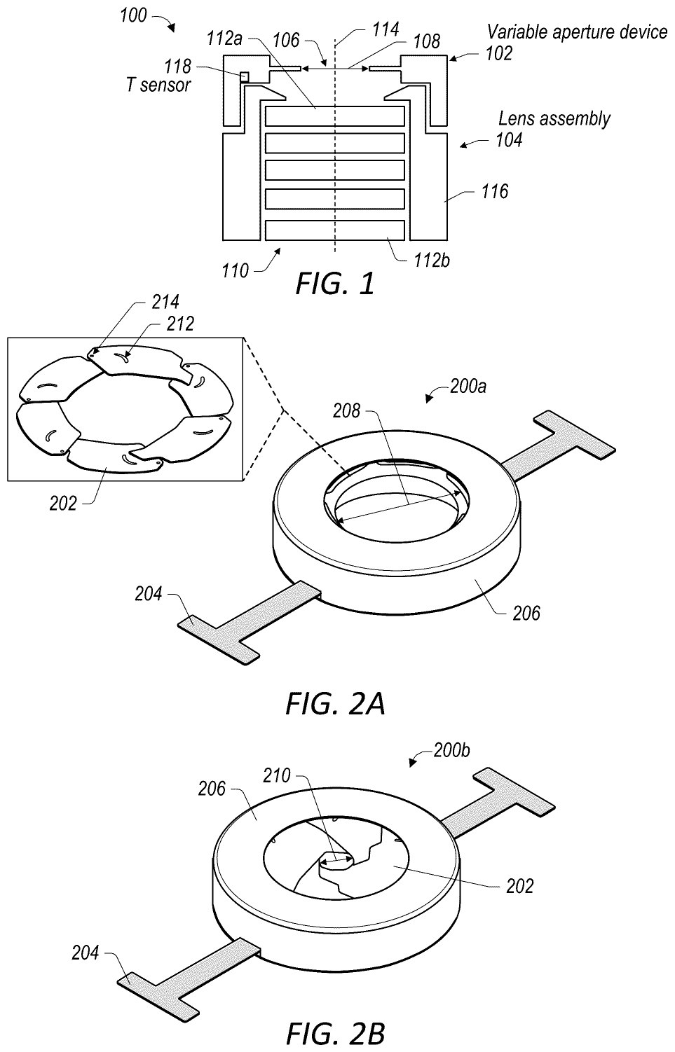

As will be discussed in further detail herein with reference to FIGS. 2A-12, the variable aperture device 102 may be configured to provide a variable aperture for the lens assembly 104 and/or the camera system 100. In various embodiments, the variable aperture device 102 may include aperture blades (e.g., aperture blades 202 in FIGS. 2A-2B) arranged to form an aperture stop, and an actuator for moving the aperture blades to change the size of the aperture within a range of aperture sizes. FIG. 1 shows an example aperture 106 having an aperture size 108, which may be changed to a different size via an actuator.

In various embodiments, the lens assembly 104 may include a lens group 110 having one or more lens elements 112 that define an optical axis 114. The aperture stop may function to limit the amount of light that reaches the lens group 110 via the aperture 106. Further, in some embodiments, the lens assembly 104 may include a lens barrel 116 that contains the lens element(s) 112, e.g., as indicated in FIG. 1. According to some non-limiting embodiments, the variable aperture device 102 may be coupled with an upper portion of the lens barrel 116. The example lens group 110 shown in FIG. 1 includes multiple stacked lens elements 112, including a “first” lens element 112a and a “last” lens element 112b. The first lens element 112a may be the lens element nearest an object side of the lens assembly 104, and the last lens element 112b may be the lens element nearest an image side of the lens assembly 104. The variable aperture device 102 may be positioned proximate the first lens element 112a, e.g., such that the aperture stop is located, in a direction parallel to the optical axis, between the first lens element 112a and an object (e.g., a subject of an image to be captured using the camera system 100). Additionally, or alternatively, the variable aperture device 102 may be positioned such that the aperture 106 is aligned with the optical axis 114, e.g., as indicated in FIG. 1. For example, the optical axis 114 may intersect the aperture 106 and/or be coincident with a central axis of the variable aperture device 102.

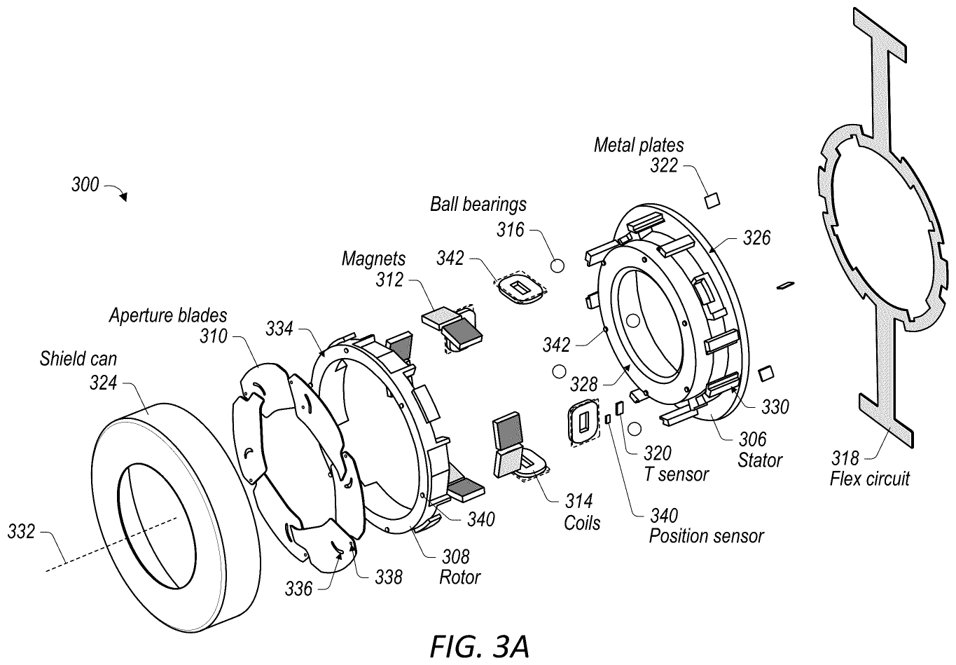

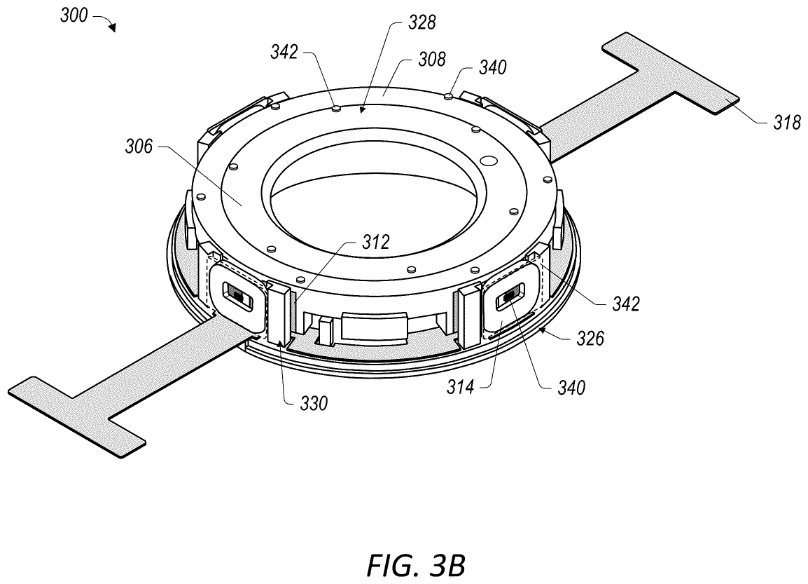

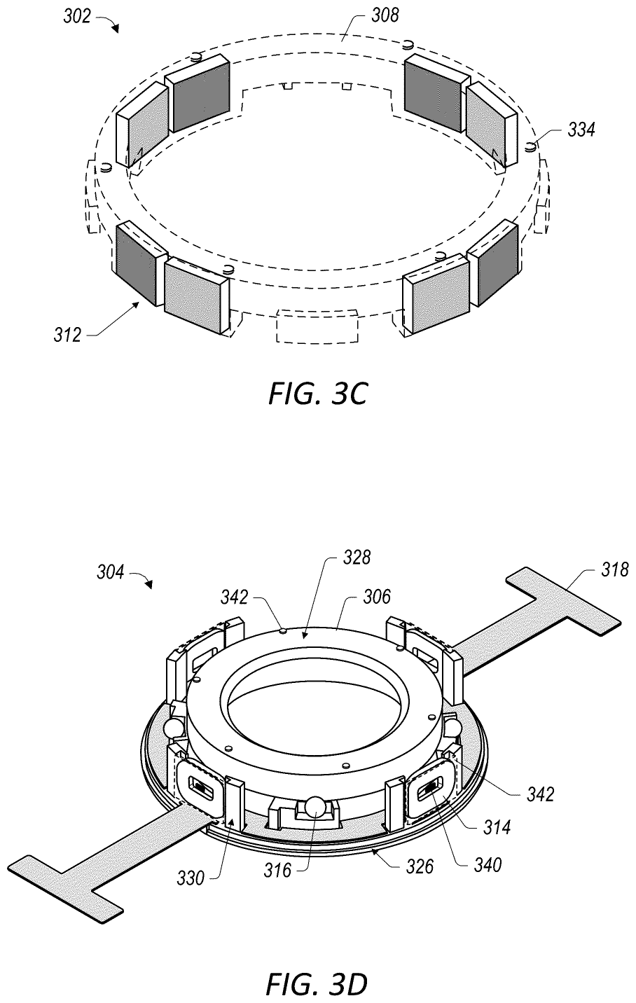

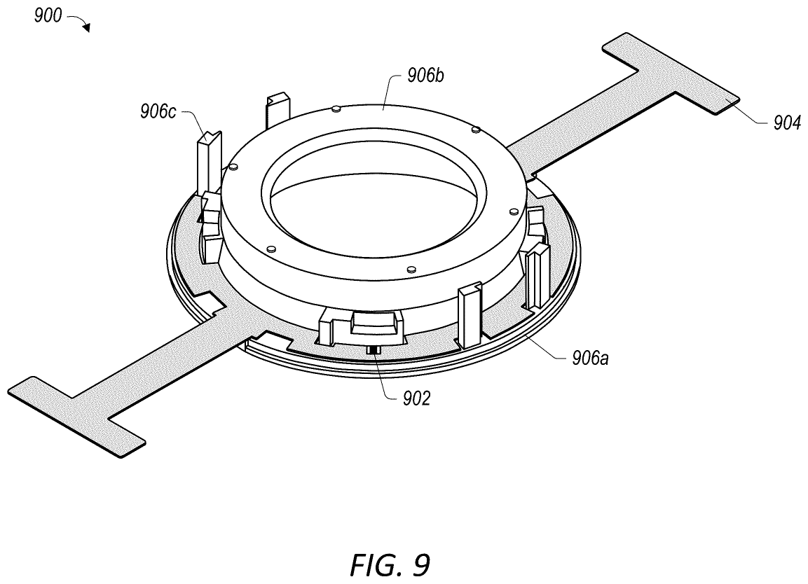

As will also be discussed with reference to FIGS. 3A and 9, the variable aperture device 102 may include one or more temperature sensors 118 (e.g., a thermistor) in some embodiments. A temperature sensor 118 may be located near the lens group 110. For example, the temperature sensor 118 may be located near the first lens element 112a in various embodiments. In some embodiments, the temperature sensor 118 may serve multiple purposes. For example, readings from the temperature sensor 118 may be used for temperature calibration for a position sensor. Additionally, or alternatively, readings from the temperature sensor 118 may be used for determining lens temperature and/or paraxial focal length (PFL) error.

Although not shown in FIG. 1, it should be understood that the camera system 100 may include various other components, such as, but not limited to, an image sensor, one or more actuators (e.g., an autofocus (AF) actuator and/or an optical image stabilization (OIS) actuator), and/or a suspension arrangement, etc. In some embodiments, the camera system 100 may be configured such that light passes through the aperture 106 and the lens group 110 before reaching the image sensor. An image plane defined by the image sensor may be orthogonal to the optical axis 114 in some embodiments. In other embodiments, camera system 100 may include a folded optics arrangement configured to redirect the light, and the image plane may be parallel to the optical axis 114 indicated in FIG. 1 or otherwise suitably oriented.

In some embodiments, the actuator(s) may include an AF actuator and/or an OIS actuator for moving the lens group 110 relative to the image sensor. Additionally, or alternatively, the actuator(s) may include an AF actuator and/or an OIS actuator for moving the image sensor relative to the lens group 110.

FIGS. 2A-2B illustrate views of an example variable aperture device 200 that may be included in a camera system (e.g., camera system 100 in FIG. 1), in accordance with some embodiments. FIG. 2A shows a perspective view of the variable aperture device 200 in a first state (also referred to herein as “first state 200a”). FIG. 2B shows a perspective view of the variable aperture device 200 in a second state (also referred to herein as “second state 200b”).

According to various embodiments, the variable aperture device 200 may include aperture blades 202, a flex circuit 204, and/or a shield can 206. The variable aperture device 200 may include additional components that are not shown in FIGS. 2A-2B. For example, the variable aperture device 200 may include components such as, but not limited to, a stator, a rotor, an actuator, a suspension arrangement, and/or sensors, etc., as described herein with reference to at least FIGS. 3A-12.

The aperture blades 202 may be arranged to form an aperture stop, e.g., as indicated in FIGS. 2A-2B. The variable aperture device 200 may include an actuator (e.g., a voice coil motor (VCM) actuator as described herein with reference to FIGS. 3A-5) for moving the aperture blades to change the size of the aperture defined by the aperture stop. The aperture stop may function to limit the amount of light that reaches a lens group (e.g., lens group 110 in FIG. 1) via the aperture.

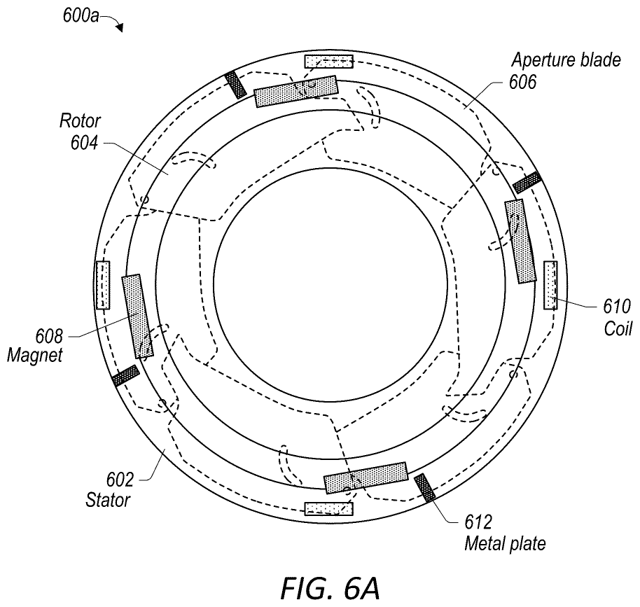

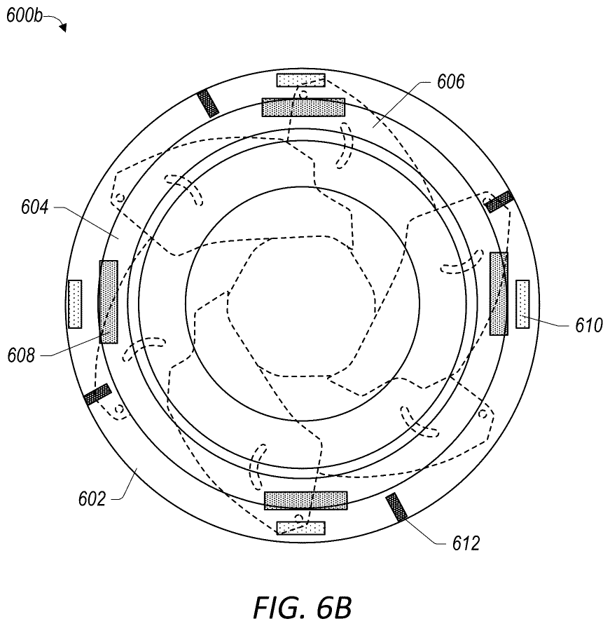

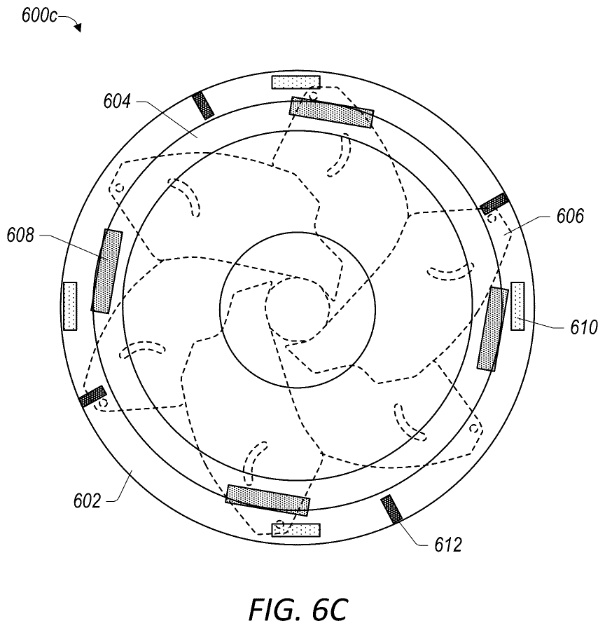

In the example first state 200a shown in FIG. 2A, the aperture blades 202 may be positioned so as to form an aperture stop that defines an aperture having a first aperture size 208. In the example second state 200b shown in FIG. 2B, the aperture blades 202 may be positioned so as to form an aperture stop that defines an aperture having a second aperture size 210 that is smaller than the first aperture size 208. In some examples, each of the first state 200a and the second state 200b may be reached by moving the aperture blades 202 via the actuator. In some embodiments, one or more aperture sizes (e.g., the first aperture size 208 in the first state 200a and/or the second aperture size 210 in the second state 200b, etc.) may be maintained while no power is being supplied to the actuator, e.g., using a locking mechanism as discussed herein with reference to FIGS. 6A-8C and 12.

According to various embodiments, the aperture blades 202 may define one or more coupling features that allow the aperture blades 202 to be coupled with one or more other components of the variable aperture device 200. In some examples, each of the aperture blades 202 may define a respective slot 212 and a respective pin hole 214. As discussed herein with reference to FIG. 3A, for example, the slots 212 may couple with pins of a rotor, and the pin holes 214 may couple with pins of a stator. The rotor may rotate relative to the stator, causing the pins of the rotor to move within the slots 212. The shape of the aperture blades 202 and the shape of the slots 212, among other things, may at least partially dictate the shape and/or size of the resulting aperture at a given position of the rotor relative to the stator.

FIGS. 3A-3D illustrate views of an example variable aperture device 300 that may be included in a camera system (e.g., camera system 100 in FIG. 1), in accordance with some embodiments. FIG. 3A shows an exploded perspective view of the variable aperture device 300. FIG. 3B shows a collapsed perspective view of the variable aperture device 300. FIG. 3C shows a perspective view of an example rotor assembly 302 of the variable aperture device 300. FIG. 3D shows a perspective view of an example stator assembly 304 of the variable aperture device 300.

According to various embodiments, the variable aperture device 300 may include a stator 306, a rotor 308, aperture blades 310, an actuator (e.g., comprising one or more magnets 312 and one or more coils 314), a suspension arrangement (e.g., a ball bearing suspension arrangement comprising ball bearings 316), a flex circuit 318, one or more sensors (e.g., comprising one or more temperature sensors 320), a locking mechanism (e.g., comprising one or more metal plates 322), and/or a shield can 324. The example rotor assembly 302 shown in FIG. 3C includes the rotor 308 along with components that may be assembled together with and/or coupled with the rotor 308 in some embodiments. The example stator assembly 304 shown in FIG. 3D includes the stator 306 along with components that maybe assembled together with and/or coupled with the stator 306 in some embodiments.

In some embodiments, the stator 306 may include a base portion 326, a central portion 328, and an outer protrusion portion 330. The central portion 328 may extend, in a first direction parallel to an axis 332 (which may be parallel to an optical axis, such as optical axis 114 in FIG. 1), from an upper surface of the base portion 326. Furthermore, the outer protrusion portion 330 may include protrusions that extend, in the first direction, from the upper surface of the base portion 326. The protrusions may be distributed in a pattern that at least partially encircles the central portion 328 in various embodiments. The upper surface of the base portion 326 may extend, in a second direction orthogonal to the axis 332, between the central portion 328 and the outer protrusion portion 330, e.g., as indicated in FIG. 3A.

According to some embodiments, the rotor 308 may include a rotor wall 334. The rotor wall 334 may be positioned, in the second direction orthogonal to the axis 332, between the central portion 328 and the outer protrusion portion 330 of the stator 306.

In various embodiments, the aperture blades 310 may be arranged to form an aperture stop. The aperture blades 310 may be coupled with the stator 306 and the rotor 308. The aperture blades 310 may be movable to change a size of an aperture defined by the aperture stop.

According to various embodiments, the actuator may be configured to rotate the rotor, relative to the stator, about the axis 332. For example, the actuator may include a first portion fixedly coupled with the rotor wall 334, and a second portion fixedly coupled with the outer protrusion portion 320 of the stator 306. Rotation of the rotor 308 may cause the aperture blades 310 to move so as to change the size of the aperture (e.g., from the first state in FIG. 2A to the second state in FIG. 2B, vice-versa, etc.).

In various embodiments, the actuator may include a voice coil motor (VCM) actuator having magnet(s) 312 and coil(s) 314. The coil(s) 314 may be positioned proximate the magnet(s) 312 such that, when driven with an electric current, the coil(s) 314 are capable of electromagnetically interacting with the magnet(s) 312 to produce Lorentz forces that rotate the rotor 308 about the axis 332. As indicated in FIGS. 3A-3D, the VCM actuator may include multiple magnet-coil groups. In various embodiments, each magnet-coil group may be opposite (e.g., relative to the aperture) another magnet-coil group with the polarity directions being oriented such that forces due to magnetic coexist and/or loads in the Z-axis direction (e.g., axis 332) are balanced/canceled out.

In a non-limiting example, the variable aperture device 300 may have two magnet-coil groups: a first magnet-coil group and a second magnet-coil group that are diametrically opposed to each other. The magnet(s) of the first magnet-coil group may have a first polarity orientation, and the magnet(s) of the second magnet-coil group may have a second polarity orientation that is the reverse of the first polarity orientation.

In another non-limiting example, the variable aperture device 300 may have four magnet-coil groups: a first magnet-coil group; a second magnet-coil group diametrically opposed to first magnet-coil group; a third magnet-coil group; and a fourth magnet-coil group diametrically opposed to the third magnet-coil group. In some embodiments, the four magnet-coil groups may be distributed around the aperture in the manner indicated in FIGS. 3A-3D. The magnet(s) of the first magnet-coil group may have a first polarity orientation, and the magnet(s) of the second magnet-coil group may have a second polarity orientation that is the reverse of the first polarity orientation. The magnet(s) of the third magnet-coil group may have a third polarity orientation, and the magnet(s) of the fourth magnet-coil group may have a fourth polarity orientation that is the reverse of the third polarity orientation.

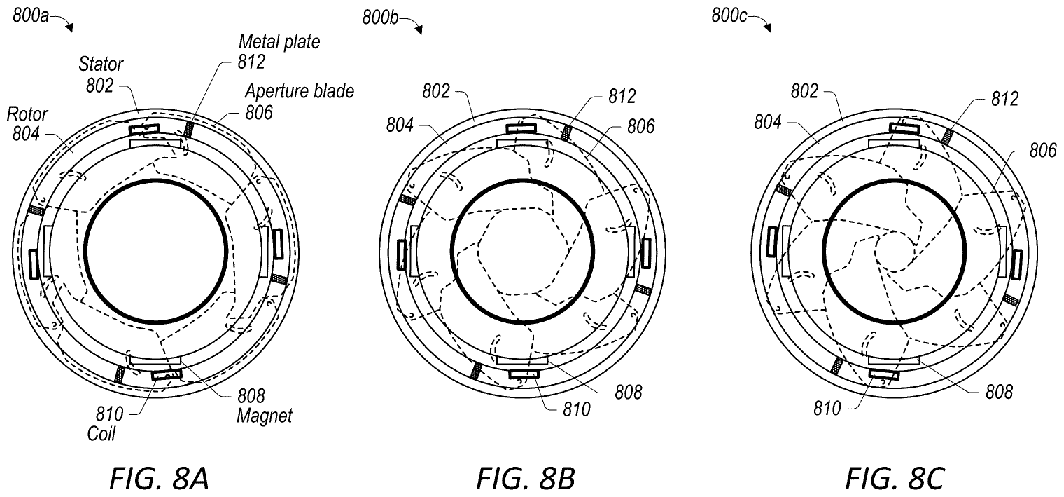

In some embodiments, the magnet(s) 312 may be fixedly coupled with the rotor 308. For example, the magnet(s) 312 may be fixedly coupled with the rotor wall 334. The coil(s) 314 may be fixedly coupled with the outer protrusion portion 320 of the stator 306. In various embodiments, some or all of the VCM components and the structures that support them may overlap in the space they consume in one or more directions orthogonal to the axis 332. In a non-limiting example, as indicated in FIG. 3A, the rotor wall 334 may define features (e.g., recesses, pockets, etc.) within which at least a portion of each magnet 312 may be accommodated/embedded. In another non-limiting example, as indicated in FIG. 3B, the protrusions of the outer protrusion portion 330 (of the stator 306) may define features (e.g., recesses, pockets, etc.) within which at least a portion of each coil 314 may be accommodated/embedded. As discussed herein with reference to FIGS. 8A-8C, in some other embodiments the coil(s) may be fixedly coupled with the rotor, and the magnet(s) may be fixedly coupled with the stator.

According to some embodiments, the aperture blades 310 may define one or more coupling features that allow the aperture blades 310 to be coupled with one or more other components of the variable aperture device 300. For example, each of the aperture blades 310 may define a respective slot 336 and a respective pin hole 338. Each of the slots 336 may couple with a respective rotor pin 340 (e.g., a pin that protrudes from the rotor wall 334, as indicated in FIG. 3A). Each of the pin holes 338 may couple with a respective stator pin 342 (e.g., a pin that protrudes from the central portion 328 of the stator 306, as indicated in FIG. 3A). Rotation of the rotor 308 relative to the stator 306 may cause the rotor pins 340 to move within the slots 336. The shape of the aperture blades 310 and the shape of the slots 336, among other things, may at least partially dictate the shape and/or size of the resulting aperture at a given position of the rotor 308 relative to the stator 306.

In various embodiments, the flex circuit 318 may configured to route/convey electrical signals (e.g., power/drive signals, sensor signals, etc.) between components within the variable aperture device 300 and/or between the variable aperture device 300 and one or more other components of the camera system. At least a portion of the flex circuit 318 may be coupled with the stator 306. For example, as discussed in more detail with reference to FIG. 9, the flex circuit 318 may include a first portion that is fixedly coupled with the base portion 326 of the stator 306. The first portion of the flex circuit 318 may at least partially encircle the central portion 328 of the stator 306. Furthermore, the flex circuit 318 may include a second portion comprising one or more arms extending from the first portion away from the stator 306, e.g., as indicated in FIG. 3B. In various embodiments, the first portion of the flex circuit 318 may contiguously encircle the central portion 342 of the stator 306. Additionally, or alternatively, the first portion of the flex circuit 318 may include one or more cutouts and/or other features that provide space accommodating the protrusions of the outer protrusion portion 330 of the stator 306 and/or accommodating one or more other components of the variable aperture device 300, e.g., as indicated in FIGS. 3A, 3B, and 3D. In various embodiments, the flex circuit 318, including the first portion and the second portion, may be part of a single-piece flex circuit, as opposed to multiple flex circuits that are coupled with one another.

According to various embodiments, the temperature sensor(s) 320 may be coupled with the flex circuit 318. For example, the temperature sensor(s) 320 may be disposed on the first portion of the flex circuit 318, which, as previously mentioned, may be fixedly coupled with the base portion 326 of the stator 306. In various embodiments, the temperature sensor(s) 320 may be positioned so as to be placed near a lens group (e.g., lens group 110 in FIG. 1) of the camera system, e.g., as also discussed herein with reference to FIGS. 1 and 9. Readings from the temperature sensor(s) 320 (sensor data) may be used for temperature calibration for one or more position sensors in some embodiments. Additionally, or alternatively, readings from the temperature sensor(s) 320 may be used for determining lens temperature and/or paraxial focal length (PFL) error.

In some embodiments, the variable aperture device 300 may include one or more position sensors 340 that may be used to determine a rotational position of the rotor 308, relative to the stator 306. According to some non-limiting embodiments, the position sensor(s) 340 may be encircled by the coil(s) 314. For example, the coil(s) 314 may be fixedly coupled with one or more structures 342, and the structure(s) 342 may be fixedly coupled with one or more protrusions of the outer protrusion portion 330 to couple the coil(s) 314 with the protrusion(s). In some embodiments, such as in those where etched coils are used, the structure(s) 342 may comprise substrates on which the etched coils were formed. However, in other embodiments, the structure(s) 342 may comprise a material capable of structurally supporting the coil(s) 314 and/or one or more other components. According to some embodiments, the position sensor(s) 340 may be fixedly coupled with the structure(s) 342. In various embodiments, a position sensor 340 may be attached to a structure 342 and located within a central space encircled by a coil 314, e.g., as indicated in FIG. 3B.

In various embodiments, the coil(s) 314 and/or the position sensor(s) 340 may be in electrical communication with the flex circuit 318, e.g., via leads and/or other electrical coupling means. In this manner, the flex circuit 318 may be used to convey electrical signals to/from the coil(s) 314 and the position sensor(s) 340. The electrical signals may be conveyed from one or more components external to the variable aperture device 300 at least partially via the second portion of the flex circuit 318. For example, the arm(s) of the second portion may be electrically coupled with one or more other flex circuits (external to the variable aperture device 300) of the camera system. Furthermore, the electrical signals may be conveyed from one component within the variable aperture device 300 to another component within the variable aperture device 300, such from one coil 314 to another coil 314, at least partially via the first portion of the flex circuit 318.

As previously indicated, the locking mechanism may include metal plate(s) 322 fixedly coupled with the stator 306 or the rotor 308. In the non-limiting example shown in FIG. 3A, multiple metal plates 322 are attached to the stator 306. In various embodiments, the variable aperture device 300 may be operable such that, when no power is supplied to the actuator (e.g., when no drive current is supplied to the coil(s) 314 of the VCM actuator), an attractive force between one or more magnetic components (e.g., the magnet(s) 312 of the VCM actuator) and the metal plate(s) 322 is sufficient to maintain a predetermined aperture size by resisting rotation of the rotor 308, relative to the stator 306, about the axis 332. Furthermore, the variable aperture device 300 may be operable such that, when a threshold amount of power is supplied to the actuator, a rotational force produced by the actuator is sufficient to overcome the attractive force between the magnetic component(s) and the metal plate(s) 322, so as to rotate the rotor 308, relative to the stator 306, about the axis 332, to change the aperture size. Embodiments of the locking mechanism are also discussed herein with reference to FIGS. 6A-8C and 12.

In some embodiments, the shield can 324 may encase at least a portion of the variable aperture device 300. For example, the shield can 324 may encase an upper portion of the variable aperture device 300, including at least a portion of the VCM actuator, in some embodiments. An upper surface of the shield can 324 may define a through hole that allows light to pass through the shield can 324 to the aperture defined by the aperture blades 310. In some embodiments, the shield can 324 may be an aluminum shield can, which may enable a reduction in size and/or mass of the variable aperture device 300, relative to some other designs utilizing another material that is denser and/or that needs to be formed with a greater thickness. For example, using aluminum for the shield can 324 may enable a reduction in size and/or mass of the variable aperture device 300, relative to some other designs that utilize copper as the shield can material.

In some embodiments, the shield can 324 and/or the aperture blades 310 may be coated with a black coating, which may be referred to as a “super-black” coating or an “ultra-black” coating. The black coating may have a very low amount of reflectivity in various embodiments. An ultra-black coating may be considered to have an even lower amount of reflectivity than a super-black coating. The black coating may be added to the shield can 324 and/or the aperture blades 310 for cosmetic purposes, as these components may have exterior surfaces that may be visible to a user/consumer of a device that includes the variable aperture device 300. Additionally, or alternatively, the black coating may be added to the shield can 324 and/or the aperture blades 310 to reduce risk of light reflecting at unwanted angles through optics of the camera system, which could result in unintended optical aberrations in an image capture.

According to various embodiments, the suspension arrangement may be configured to suspend the rotor 308 on the stator 306 and allow the rotor 308 to rotate relative to the stator 306. As previously mentioned, the suspension arrangement may be a ball bearing suspension arrangement in some embodiments. The ball bearings 316 of the ball bearing suspension arrangement may be disposed, in a direction orthogonal to the axis 332, between stator 306 and the rotor 308. For example, a portion of the stator 306 and/or a portion of the rotor 308 may define one or more tracks within which the ball bearings 316 may reside and allow for the rotational movement of the rotor 308 relative to the stator 306.

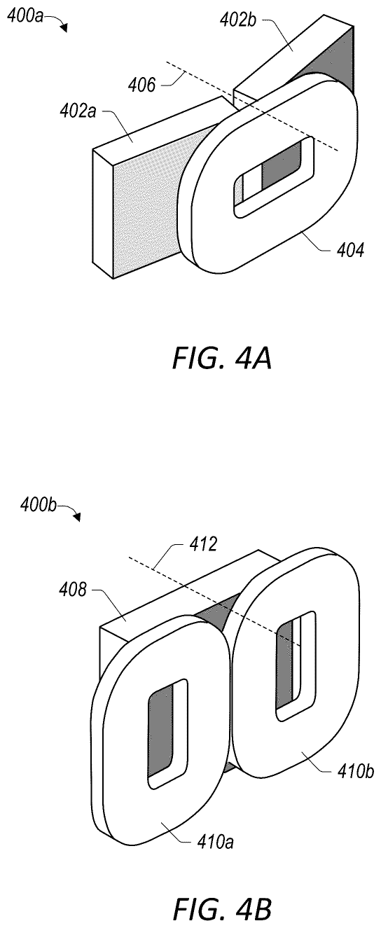

FIGS. 4A-4B illustrate views of respective example electromagnetic arrangements 400 that may be used in a voice coil motor (VCM) actuator of a variable aperture device (e.g., variable aperture device 102 in FIG. 1, variable aperture device 200 in FIGS. 2A-2B, variable aperture device 300 in FIGS. 3A-3D, etc.), in accordance with some embodiments. FIG. 4A shows a perspective view of an electromagnetic arrangement 400a that includes a dual-pole magnet in a magnet-coil group with a single coil. FIG. 4B shows a perspective view of an electromagnetic arrangement 400b that includes a single-pole magnet in a magnet-coil group with multiple coils.

As indicated in FIG. 4A, the magnet-coil group in electromagnetic arrangement 400a may include a dual-pole magnet arrangement 402 and a coil 404. In some embodiments, the dual-pole magnet arrangement 402 may comprise two single-pole magnets (e.g., single-pole magnet 402a and single-pole magnet 402b) positioned near one another with opposite polarity directions facing the coil 404, e.g., as indicated in FIG. 4A. In the non-limiting examples of magnet arrangements shown in the figures, the relatively lighter shade (e.g., the shade on the face of magnet 402a facing the coil 404) indicates a first polarity direction (e.g., north or south), and the relatively darker shade (e.g., the shade on the face of magnet 402b facing the coil 404 indicates a second polarity direction (e.g., north or south) that is opposite/the reverse of the first polarity direction. In some embodiments, the dual-pole magnet arrangement 402 may comprise a dual-pole magnet formed by coupling two single-pole magnets (e.g., single-pole magnet 402a and single-pole magnet 402b) with a non-magnetic material placed between them, the combination being joined to form a single-piece dual-pole magnet.

According to some embodiments, the coil 404 may be oriented such that it has a longest dimension in a direction that is orthogonal to an optical axis (e.g., optical axis 114 in FIG. 1). In various embodiments, a central portion of the dual-pole magnet arrangement 402 may be aligned with a central portion of the coil 404, e.g., as indicated by broken line 406 intersecting a central portion of the dual-pole magnet arrangement 402 and a central portion of the coil 404.

As indicated in FIG. 4B, the magnet-coil group in electromagnetic arrangement 400b may include a single-pole magnet 408 and a multi-coil arrangement 410. For example, the multi-coil arrangement 410 may include a first coil 410a and a second coil 410b. The first coil 410a and the second coil 410b may be positioned side-by-side each other. According to some embodiments, each of the first coil 410a and the second coil 410b may be oriented such that it has a longest dimension that is parallel to an optical axis (e.g., optical axis 114 in FIG. 1). A central portion of the single-pole magnet 408 may be aligned with a central portion of the multi-coil arrangement 410, e.g., as indicated by broken line 412 intersecting a central portion of the single-pole magnet 408 and a central portion of the multi-coil arrangement 410.

In some embodiments, the coils in the electromagnetic arrangement 400a and in the electromagnetic arrangement 400b may include etched coils. The process of etching a coil may include selectively removing portions of a conductive material (e.g., copper) on a substrate to create a coil structure. This is typically accomplished using an etching technique, and a masking pattern may be employed to define the areas where the conductive material will be preserved and the areas that will be etched away.

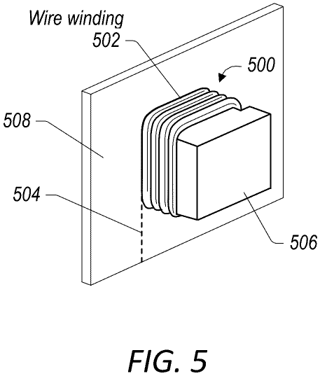

Additionally, or alternatively, the coils may include wound coils. For example, FIG. 5 illustrates a perspective view of an example wound coil 500 that may be used in a voice coil motor (VCM) actuator of a variable aperture device (e.g., variable aperture device 102 in FIG. 1, variable aperture device 200 in FIGS. 2A-2B, variable aperture device 300 in FIGS. 3A-3D, etc.), in accordance with some embodiments. The wound coil 500 may include a wire windings 502 and a wire lead portion 504 (schematically shown in FIG. 5). In various embodiments, the wire winding portion 502 may include a portion of the wound coil 500 that is wound around a carriage 506. The carriage 506 may be attached to one or more support structures 508 and oriented such that the wire windings 502 are appropriately oriented relative to the magnet(s) in the same magnet-coil group. In some embodiments, the support structure 508 may be the same as, or similar to, the structure 342 described herein with reference to FIGS. 3A-3D.

FIGS. 6A-6C illustrate views of an example variable aperture device 600 that may be included in a camera system (e.g., camera system 100 in FIG. 1) and that may include a locking mechanism, in accordance with some embodiments. FIG. 6A shows a schematic top view of the variable aperture device 600 in an example locked position (also referred to herein as “locked state 600a”). FIG. 6B shows a schematic top view of the variable aperture device 600 in a first example unlocked position (also referred to herein as “first unlocked state 600b”). FIG. 6C shows a schematic top view of the variable aperture device 600 in a second example unlocked position (also referred to herein as “second unlocked state 600c”).

According to various embodiments, the variable aperture device 600 may include a stator 602, a rotor 604, aperture blades 606, a voice coil motor (VCM) actuator (e.g., comprising one or more magnets 608 and one or more coils 610), and a locking mechanism (e.g., comprising one or more metal plates 612).

In various embodiments, the magnet(s) 608 may be fixedly coupled with the rotor 604. The coil(s) 610 may be fixedly coupled with the stator 602. Power may be supplied to the coil(s) 610 to cause (via electromagnetic interaction with the magnet(s) 608, producing Lorentz forces) the rotor 604 to rotate relative to the stator 602. Rotation of the rotor 604 may cause the aperture blades 606 to move and change the aperture size, as discussed throughout this disclosure.

As indicated in FIGS. 6A-6C, the metal plate(s) 612 may be fixedly coupled with the stator 602. According to various embodiments, the locking mechanism may be designed so that the metal plate(s) 612 are capable of magnetically interacting with the magnet(s) 608 in certain positions of the rotor 604 relative to the stator 602. In one or more positions, the metal plate(s) 612 may be positioned sufficiently near the magnet(s) 608 so that an attractive force between the metal plate(s) 612 and the magnet(s) 608 is strong enough to maintain the rotor 604 stationary relative to the stator 602 when no power is supplied to the VCM actuator (e.g., when no electric current is supplied to the coil(s) 610). By locking the position in this manner, an aperture size corresponding to the position may be maintained without any power being supplied to the VCM actuator.

The locked state 600a shown in FIG. 6A is an example in which the locking mechanism is designed to maintain a zero-power aperture size that is bigger than the aperture sizes indicated in FIGS. 6B-6C. In some non-limiting embodiments, the locking mechanism may be designed so that the zero-power aperture size to be maintained in a locked state is the biggest aperture size within the range of aperture sizes that the variable aperture device 600 is capable of forming with the aperture blades 606. As indicated in FIG. 6A, each respective magnet 608 is located near a respective metal plate 612.

In various embodiments, power may be supplied to the VCM actuator to rotate the rotor 604 relative to the stator 602. Rotation of the rotor 604 may move the aperture blades 606 and cause the aperture size to change. For example, with sufficient power supplied to the VCM, resulting Lorentz forces may satisfy a threshold force that overcomes the attractive forces between the magnet(s) 608 and the metal plate(s) 612, thereby allowing the rotor 604 to break free from the locked state and to transition to one or more unlocked states, such as the first unlocked state 600b shown in FIG. 6B, the second unlocked state 600c shown in FIG. 6C, etc.

In some embodiments, the first unlocked state 600b shown in FIG. 6B may be an example in which power is supplied to the VCM actuator and rotation of the rotor 604 (and thus the magnet(s) 608 fixedly coupled therewith) causes the magnet(s) 608 to move further away from the metal plate(s) 612, relative to their relative distance in the locked state 600a shown in FIG. 6A. The rotation of the rotor 604 also moves the aperture blades 606 so as to make the aperture size smaller, relative to the aperture size in the locked state 600a shown in FIG. 6A.

In some embodiments, the second unlocked state 600c shown in FIG. 6C may be an example in which power is supplied to the VCM actuator and rotation of the rotor 604 (and thus the magnet(s) 608 fixedly coupled therewith) causes the magnet(s) 608 to move further away from the metal plate(s) 612, relative to their distance in the first unlocked state 600b shown in FIG. 6B. The rotation of the rotor 604 also moves the aperture blades 606 so as to make the aperture size smaller, relative to the aperture size in the first unlocked state 600b shown in FIG. 6B.

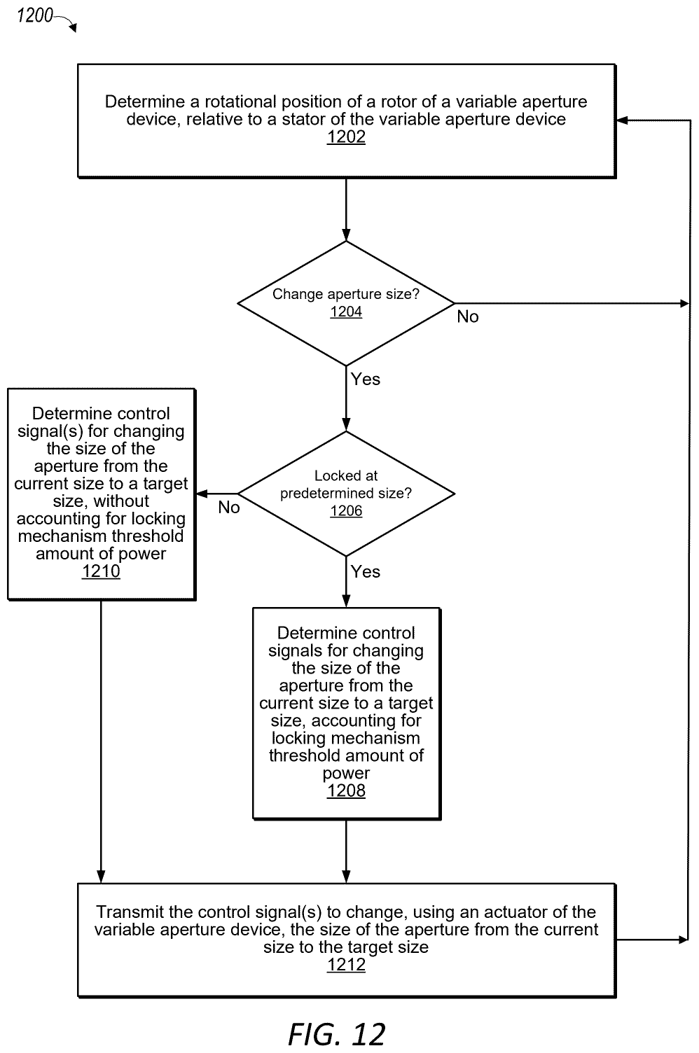

As discussed herein with reference to FIG. 12, the amount of power required to move from the locked state to one or more unlocked states initially be a relatively higher amount of power to overcome the attractive force of the locking mechanism, and then relatively lower to move the rotor to the target rotational position as the rotational distance between the magnet(s) 608 and the metal plate(s) 612 increases.

While not shown in FIGS. 6A-6C, in various embodiments the locking mechanism may include metal plates 612 at various different positions so as to be capable of having multiple locked states at multiple different aperture sizes. For example, in some cases two or more aperture sizes may be frequently used relative to other aperture sizes. The variable aperture device 600 may be designed so that the locking mechanism can implement locked states at multiple ones of the frequently used aperture sizes, thereby conserving power.

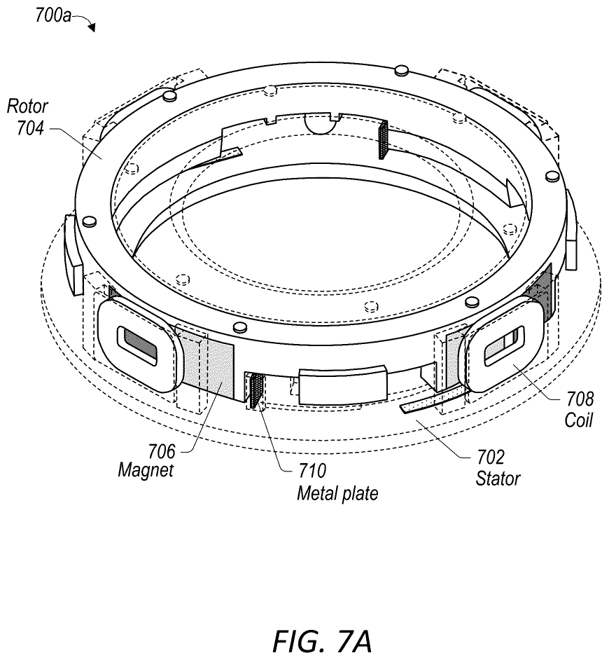

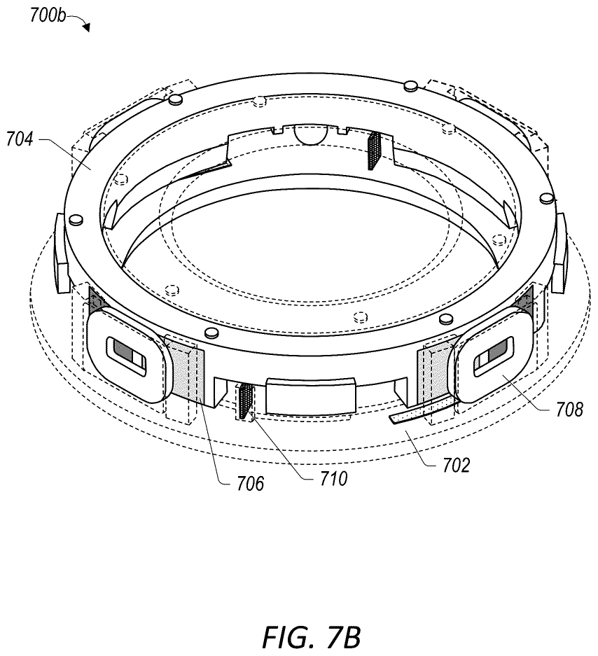

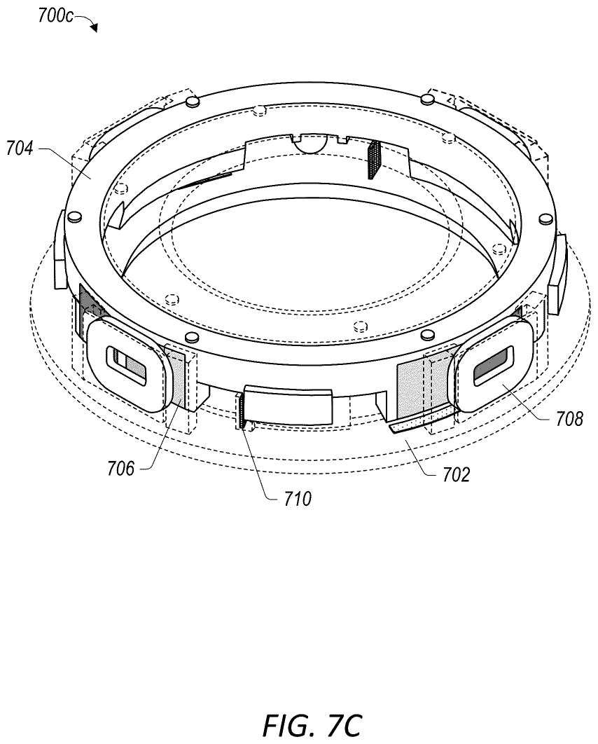

FIGS. 7A-7C illustrate views of an example variable aperture device 700 that may be included in a camera system (e.g., camera system 100 in FIG. 1) and that may include a locking mechanism, in accordance with some embodiments. FIG. 7A shows a schematic top view of the variable aperture device 700 in an example locked position (also referred to herein as “locked state 700a”). FIG. 7B shows a schematic top view of the variable aperture device 700 in a first example unlocked position (also referred to herein as “first unlocked state 700b”). FIG. 7C shows a schematic top view of the variable aperture device 700 in a second example unlocked position (also referred to herein as “second unlocked state 700c”).

According to various embodiments, the variable aperture device 600 may include a stator 702, a rotor 704, aperture blades (e.g., aperture blades 606 in FIG. 6), a voice coil motor (VCM) actuator (e.g., comprising one or more magnets 706 and one or more coils 708), and a locking mechanism (e.g., comprising one or more metal plates 710).

In various embodiments, the magnet(s) 706 may be fixedly coupled with the rotor 704. The coil(s) 708 may be fixedly coupled with the stator 702. Power may be supplied to the coil(s) 708 to cause the rotor 704 to rotate relative to the stator 702. Rotation of the rotor 704 may cause the aperture blades to move and change the aperture size, as discussed throughout this disclosure.

As indicated in FIGS. 7A-7C, the metal plate(s) 710 may be fixedly coupled with the stator 702. For example, the metal plate(s) 710 may be at least partially embedded within the stator 702, e.g., as indicated in FIGS. 7A-7C. In some non-limiting embodiments, each metal plate 710 may be at least partially embedded within a feature (e.g., a recess, a pocket, etc.) defined by the stator 702. According to various embodiments, the locking mechanism may be designed so that the metal plate(s) 710 are capable of magnetically interacting with the magnet(s) 706 in certain positions of the rotor 704 relative to the stator 702. In one or more positions, the metal plate(s) 710 may be positioned sufficiently near the magnet(s) 706 so that an attractive force between the metal plate(s) 710 and the magnet(s) 706 is strong enough to maintain the rotor 704 stationary relative to the stator 702 when no power is supplied to the VCM actuator (e.g., when no electric current is supplied to the coil(s) 708). By locking the position in this manner, an aperture size corresponding to the position may be maintained without any power being supplied to the VCM actuator.

The locked state 700a shown in FIG. 7A is an example in which the locking mechanism is designed to maintain a zero-power aperture size that is bigger than the aperture sizes indicated in FIGS. 7B-7C. In some non-limiting embodiments, the locking mechanism may be designed so that the zero-power aperture size to be maintained in a locked state is the biggest aperture size within the range of aperture sizes that the variable aperture device 700 is capable of forming with the aperture blades. As indicated in FIG. 7A, each respective magnet 706 is located near a respective metal plate 710.

In various embodiments, power may be supplied to the VCM actuator to rotate the rotor 704 relative to the stator 702. Rotation of the rotor 704 may move the aperture blades and cause the aperture size to change. For example, with sufficient power supplied to the VCM, resulting Lorentz forces may satisfy a threshold force that overcomes the attractive forces between the magnet(s) 706 and the metal plate(s) 710, thereby allowing the rotor 704 to break free from the locked state and to transition to one or more unlocked states, such as the first unlocked state 700b shown in FIG. 7B, the second unlocked state 700c shown in FIG. 7C, etc.

In some embodiments, the first unlocked state 700b shown in FIG. 7B may be an example in which power is supplied to the VCM actuator and rotation of the rotor 704 (and thus the magnet(s) 706 fixedly coupled therewith) causes the magnet(s) 706 to move further away from the metal plate(s) 710, relative to their distance in the locked state 700a shown in FIG. 7A. The rotation of the rotor 704 also moves the aperture blades so as to make the aperture size smaller, relative to the aperture size in the locked state 700a.

In some embodiments, the second unlocked state 700c shown in FIG. 7C may be an example in which power is supplied to the VCM actuator and rotation of the rotor 704 (and thus the magnet(s) 706 fixedly coupled therewith) causes the magnet(s) 706 to move further away from the metal plate(s) 710, relative to their distance in the first unlocked state 700b shown in FIG. 6B. The rotation of the rotor 704 also moves the aperture blades so as to make the aperture size smaller, relative to the aperture size in the first unlocked state 700b.

While not shown in FIGS. 7A-7C, in various embodiments the locking mechanism may include metal plates 710 at various different positions so as to be capable of having multiple locked states at multiple different aperture sizes. For example, in some cases two or more aperture sizes may be frequently used relative to other aperture sizes. The variable aperture device 700 may be designed so that the locking mechanism can implement locked states at multiple ones of the frequently used aperture sizes, thereby conserving power.

FIGS. 8A-8C illustrate views of an example variable aperture device 800 that may be included in a camera system (e.g., camera system 100 in FIG. 1) and that may include a locking mechanism, in accordance with some embodiments. FIG. 8A shows a schematic top view of the variable aperture device 800 in an example locked position (also referred to herein as “locked state 800a”). FIG. 8B shows a schematic top view of the variable aperture device 800 in a first example unlocked position (also referred to herein as “first unlocked state 800b”). FIG. 8C shows a schematic top view of the variable aperture device 800 in a second example unlocked position (also referred to herein as “second unlocked state 800c”).

According to various embodiments, the variable aperture device 800 may include a stator 802, a rotor 804, aperture blades 806, a voice coil motor (VCM) actuator (e.g., comprising one or more magnets 808 and one or more coils 810), and a locking mechanism (e.g., comprising one or more metal plates 812).

In various embodiments, the coil(s) 810 may be fixedly coupled with the rotor 804. The magnet(s) 808 may be fixedly coupled with the stator 802. Power may be supplied to the coil(s) 810 to cause the rotor 804 to rotate relative to the stator 802. Rotation of the rotor 804 may cause the aperture blades 806 to move and change the aperture size, as discussed throughout this disclosure.

As indicated in FIGS. 8A-8C, the metal plate(s) 812 may be fixedly coupled with the rotor 804. According to various embodiments, the locking mechanism may be designed so that the metal plate(s) 812 are capable of magnetically interacting with the magnet(s) 808 in certain positions of the rotor 804 relative to the stator 802. In one or more positions, the metal plate(s) 812 may be positioned sufficiently near the magnet(s) 808 so that an attractive force between the metal plate(s) 812 and the magnet(s) 808 is strong enough to maintain the rotor 804 stationary relative to the stator 802 when no power is supplied to the VCM actuator (e.g., when no electric current is supplied to the coil(s) 810). By locking the position in this manner, an aperture size corresponding to the position may be maintained without any power being supplied to the VCM actuator.

The locked state 800a shown in FIG. 8A is an example in which the locking mechanism is designed to maintain a zero-power aperture size that is bigger than the aperture sizes indicated in FIGS. 8B-8C. In some non-limiting embodiments, the locking mechanism may be designed so that the zero-power aperture size to be maintained in a locked state is the biggest aperture size within the range of aperture sizes that the variable aperture device 800 is capable of forming with the aperture blades 806. As indicated in FIG. 8A, each respective magnet 808 is located near a respective metal plate 812.

In various embodiments, power may be supplied to the VCM actuator to rotate the rotor 804 relative to the stator 802. Rotation of the rotor 804 may move the aperture blades 806 and cause the aperture size to change. For example, with sufficient power supplied to the VCM, resulting Lorentz forces may satisfy a threshold force that overcomes the attractive forces between the magnet(s) 808 and the metal plate(s) 812, thereby allowing the rotor 804 to break free from the locked state and to transition to one or more unlocked states, such as the first unlocked state 800b shown in FIG. 8B, the second unlocked state 800c shown in FIG. 8C, etc.

In some embodiments, the first unlocked state 800b shown in FIG. 8B may be an example in which power is supplied to the VCM actuator and rotation of the rotor 804 (and thus the coil(s) 810 fixedly coupled therewith) causes the metal plate(s) 812 to move further away from the magnet(s) 808 (which are fixedly coupled with the stator 802), relative to their relative distance in the locked state 800a shown in FIG. 8A. The rotation of the rotor 804 also moves the aperture blades 806 so as to make the aperture size smaller, relative to the aperture size in the locked state 800a shown in FIG. 8A.

In some embodiments, the second unlocked state 800c shown in FIG. 8C may be an example in which power is supplied to the VCM actuator and rotation of the rotor 804 (and thus the coil(s) 810 fixedly coupled therewith) causes the metal plate(s) 812 to move further away from the magnet(s) 808, relative to their distance in the first unlocked state 800b shown in FIG. 8B. The rotation of the rotor 804 also moves the aperture blades 806 so as to make the aperture size smaller, relative to the aperture size in the first unlocked state 800b shown in FIG. 8B.

While not shown in FIGS. 8A-8C, in various embodiments the locking mechanism may include metal plates 812 at various different positions so as to be capable of having multiple locked states at multiple different aperture sizes. For example, in some cases two or more aperture sizes may be frequently used relative to other aperture sizes. The variable aperture device 800 may be designed so that the locking mechanism can implement locked states at multiple ones of the frequently used aperture sizes, thereby conserving power.

FIG. 9 illustrates a perspective view of an example temperature sensing arrangement 900 that may be used in a variable aperture device (e.g., variable aperture device 102 in FIG. 1, variable aperture device 200 in FIGS. 2A-2B, variable aperture device 300 in FIGS. 3A-3D, variable aperture device 600 in FIGS. 6A-6C, variable aperture device 700 in FIGS. 7A-7C, and/or variable aperture device 800 in FIGS. 8A-8C, etc.) that may be included in a camera system (e.g., camera system 100 in FIG. 1), in accordance with some embodiments.

According to various embodiments, the temperature sensing arrangement 900 may include one or more temperature sensors (e.g., temperature sensor 902). For example, the temperature sensor(s) 902 may include a thermistor in some non-limiting embodiments. The temperature sensor(s) 902 may be coupled with a flex circuit 904, e.g., as indicated in FIG. 9. The flex circuit 904 may be coupled with a stator 906. In some embodiments, the stator 906 may include a base portion 906a, a central portion 906b, and an outer protrusion portion 906c. The flex circuit 904 may include a first portion that is disposed on an upper surface of the base portion 906 of the stator 906, e.g., as indicated in FIG. 9. The first portion of the flex circuit 904 may at least partially encircle the central portion 906b of the stator 906. In some embodiments, the first portion of the flex circuit 904 may include one or more cutout portions providing space that accommodates the protrusions of the outer protrusion portion 906c of the stator 906.

In some embodiments, the flex circuit 904 may include a second portion comprising one or more arms extending from the first portion away from the stator 906. For example, as indicated in FIG. 9, the second portion of the flex circuit 904 may include a first arm extending from the first portion in a first direction away from the stator 906, and a second arm extending from the first portion in a second direction (e.g., opposite the first direction) away from the stator 906. In some embodiments, the arm(s) may be used to route/convey electrical signals (e.g., power and/or drive signals, etc.) between the variable aperture device and one or more other components in the camera system. In some embodiments, the electrical signals may be routed via electrical traces (not shown) on the flex circuit 904 to drive coils of a voice coil motor (VCM) actuator (e.g., embodiments of the VCM actuator(s) described herein with reference to FIGS. 3A-8C) of the variable aperture device.

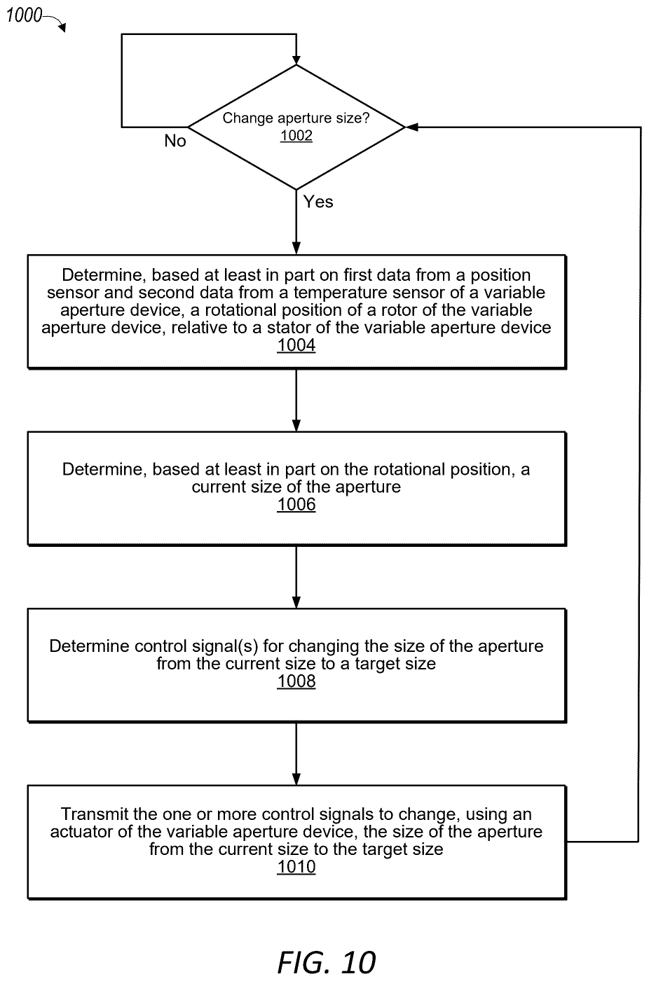

FIG. 10 is a flowchart that illustrates an example method 1000 of controlling an aperture size of a variable aperture device (e.g., a variable aperture device as described herein with reference to FIGS. 1-8C) based at least in part on temperature data from a temperature sensor (e.g., temperature sensor 320 in FIG. 3A, temperature sensor 902 in FIG. 9, etc.) of the variable aperture device, in accordance with some embodiments.

At 1002, the method 1000 may include determining whether a change in aperture size is triggered. If, at 1002, it is determined that a change in aperture size is triggered, then the method 1000 may include, at 1004, determining a rotational position of a rotor of the variable aperture device, relative to a stator of the variable aperture device. For example, the rotational position may be determined based at least in part on first data from a position sensor (e.g., position sensor 340 in FIG. 3A) and second data from the temperature sensor. At 1006, the method 1000 may include determining, based at least in part on the rotational position, a current size of the aperture. At 1008, the method 1000 may include determining one or more control signals for changing the size of the aperture from the current size to a target size. At 1010, the method 1000 may include transmitting the control signal(s) to change, using an actuator of the variable aperture device, the size of the aperture from the current size to the target size. If, at 1002, it is determined that a change in aperture size is not triggered, the method 1000 may include continuing to monitor whether a change in aperture size is triggered.

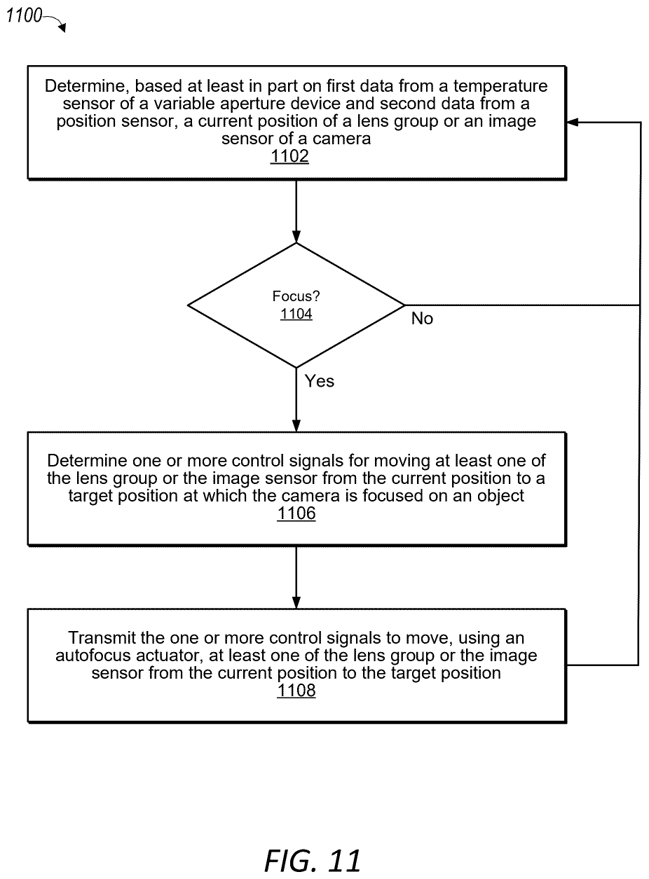

FIG. 11 is a flowchart that illustrates an example method 1100 of controlling a focus position based at least in part on temperature data from a temperature sensor (e.g., temperature sensor 320 in FIG. 3A, temperature sensor 902 in FIG. 9, etc.) of a variable aperture device (e.g., a variable aperture device as described herein with reference to FIGS. 1-8C), in accordance with some embodiments.

At 1102, the method 1100 may include determining a current position of a lens group or an image sensor of a camera. For example, the current position may be determined based at least in part on first data from a temperature sensor of a variable aperture device and second data from a position sensor. At 1104, the method 1100 may include determining whether a change in focus is triggered. If, at 1104, it is determined that a change in focus is triggered, then the method 1100 may include determining one or more control signals for moving at least one of the lens group or the image sensor from the current position to a target position at which the camera is focused on an object. At 1108, the method 1100 may include transmitting the one or more control signals to move, using an autofocus actuator, at least one of the lens group or the image sensor from the current position to the target position. If, at 1104, it is determined that a change in focus is not triggered, then the method 1100 may include continuing to determine the current position (at 1102) and/or continuing to monitor whether a change in focus is triggered (at 1104).

FIG. 12 is a flowchart that illustrates an example method 1200 of controlling an aperture size of a variable aperture device (e.g., a variable aperture device as described herein with reference to FIGS. 1-8C) that includes a locking mechanism (e.g., a locking mechanism as described herein with reference to FIGS. 6A-8C), in accordance with some embodiments.

At 1202, the method 1200 may include determining a rotational position of a rotor of a variable aperture device, relative to a stator of the variable aperture device. At 1204, the method 1200 may include determining whether a change in aperture size is triggered. If, at 1204, it is determined that a change in aperture size is triggered, then the method 1200 may include, at 1206, determining whether the aperture is locked (via the locking mechanism) at a predetermined aperture size. If, at 1206, it is determined that the aperture is locked at the predetermined aperture size, then the method 1200 may include, at 1208, determining control signals for changing the size of the aperture from the current size to a target size, accounting for a locking mechanism threshold amount of power. If, at 1206, it is determined that the aperture is not locked at the predetermined aperture size, then the method 1200 may include, at 1210, determining one or more control signals for changing the size of the aperture from the current size to a target size, without accounting for a locking mechanism threshold amount of power. At 1212, the method 1200 may include transmitting the control signal(s) to change, using an actuator of the variable aperture device, the size of the aperture from the current size to the target size.

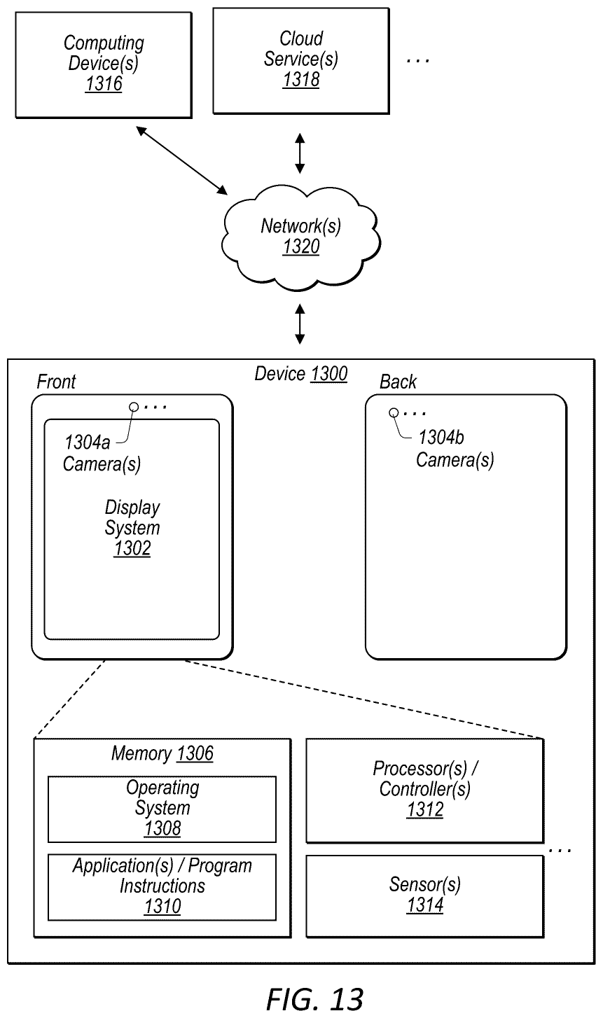

FIG. 13 illustrates a schematic representation of an example environment comprising a device 1300 that may include one or more cameras. In various examples, the device 1300 may include a camera with a variable aperture device, e.g., as described herein with reference to FIGS. 1-12. In some embodiments, the device 1300 may be a mobile device and/or a multifunction device. In various embodiments, the device 1300 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In some embodiments, the device 1300 may include a display system 1302 (e.g., comprising a display and/or a touch-sensitive surface) and/or one or more cameras 1304. In some non-limiting embodiments, the display system 1302 and/or one or more front-facing cameras 1304a may be provided at a front side of the device 1300, e.g., as indicated in FIG. 13. Additionally, or alternatively, one or more rear-facing cameras 1304b may be provided at a rear side of the device 1300. In some embodiments comprising multiple cameras 1304, some or all of the cameras 1304 may be the same as, or similar to, each other. Additionally, or alternatively, some or all of the cameras 1304 may be different from each other. In various embodiments, the location(s) and/or arrangement(s) of the camera(s) 1304 may be different than those indicated in FIG. 13.

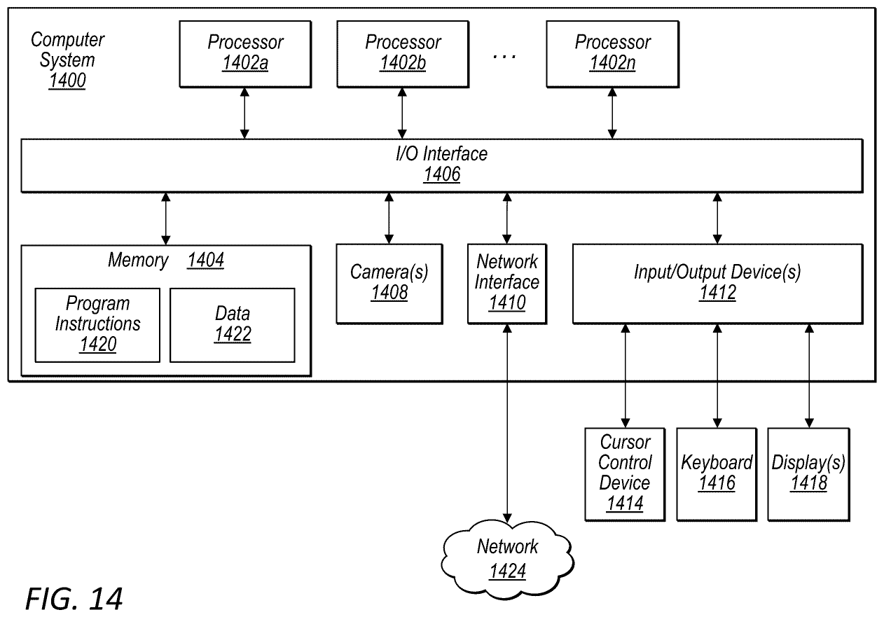

Among other things, the device 1300 may include memory 1306 (e.g., comprising an operating system 1308 and/or application(s)/program instructions 1310), one or more processors and/or controllers 1312 (e.g., comprising CPU(s), memory controller(s), display controller(s), and/or camera controller(s), etc.), and/or one or more sensors 1314 (e.g., orientation sensor(s), proximity sensor(s), and/or position sensor(s), etc.). In some embodiments, the device 1300 may communicate with one or more other devices and/or services, such as computing device(s) 1316, cloud service(s) 1318, etc., via one or more networks 1320. For example, the device 1300 may include a network interface (e.g., network interface 1410 in FIG. 14) that enables the device 1300 to transmit data to, and receive data from, the network(s) 1320. Additionally, or alternatively, the device 1300 may be capable of communicating with other devices via wireless communication using any of a variety of communications standards, protocols, and/or technologies.

FIG. 14 illustrates a schematic block diagram of an example environment comprising a computer system 1400 that may include a camera with a variable aperture device, e.g., as described herein with reference to FIGS. 1-13. In addition, computer system 1400 may implement methods for controlling operations of the camera and/or for performing image processing on images captured with the camera. In some embodiments, the device 1300 (described herein with reference to FIG. 13) may additionally, or alternatively, include some or all of the functional components of the described herein.

The computer system 1400 may be configured to execute any or all of the embodiments described above. In different embodiments, computer system 1400 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In the illustrated embodiment, computer system 1400 includes one or more processors 1402 coupled to a system memory 1404 via an input/output (I/O) interface 1406. Computer system 1400 further includes one or more cameras 1408 coupled to the I/O interface 1406. Computer system 1400 further includes a network interface 1410 coupled to I/O interface 1406, and one or more input/output devices 1412, such as cursor control device 1414, keyboard 1416, and display(s) 1418. In some cases, it is contemplated that embodiments may be implemented using a single instance of computer system 1400, while in other embodiments multiple such systems, or multiple nodes making up computer system 1400, may be configured to host different portions or instances of embodiments. For example, in one embodiment some elements may be implemented via one or more nodes of computer system 1400 that are distinct from those nodes implementing other elements.

In various embodiments, computer system 1400 may be a uniprocessor system including one processor 1402, or a multiprocessor system including several processors 1402 (e.g., two, four, eight, or another suitable number). Processors 1402 may be any suitable processor capable of executing instructions. For example, in various embodiments processors 1402 may be general-purpose or embedded processors implementing any of a variety of instruction set architectures (ISAs), such as the x86, PowerPC, SPARC, or MIPS ISAs, or any other suitable ISA. In multiprocessor systems, each of processors 1402 may commonly, but not necessarily, implement the same ISA.

System memory 1404 may be configured to store program instructions 1420 accessible by processor 1402. In various embodiments, system memory 1404 may be implemented using any suitable memory technology, such as static random access memory (SRAM), synchronous dynamic RAM (SDRAM), nonvolatile/Flash-type memory, or any other type of memory. Additionally, existing camera control data 1422 of memory 1404 may include any of the information or data structures described above. In some embodiments, program instructions 1420 and/or data 1422 may be received, sent, or stored upon different types of computer-accessible media or on similar media separate from system memory 1404 or computer system 1400. In various embodiments, some or all of the functionality described herein may be implemented via such a computer system 1400.

In one embodiment, I/O interface 1406 may be configured to coordinate I/O traffic between processor 1402, system memory 1404, and any peripheral devices in the device, including network interface 1410 or other peripheral interfaces, such as input/output devices 1412. In some embodiments, I/O interface 1406 may perform any necessary protocol, timing, or other data transformations to convert data signals from one component (e.g., system memory 1404) into a format suitable for use by another component (e.g., processor 1402). In some embodiments, I/O interface 1406 may include support for devices attached through various types of peripheral buses, such as a variant of the Peripheral Component Interconnect (PCI) bus standard or the Universal Serial Bus (USB) standard, for example. In some embodiments, the function of I/O interface 1406 may be split into two or more separate components, such as a north bridge and a south bridge, for example. Also, in some embodiments some or all of the functionality of I/O interface 1406, such as an interface to system memory 1404, may be incorporated directly into processors 1402.

Network interface 1410 may be configured to allow data to be exchanged between computer system 1400 and other devices attached to a network 1424 (e.g., carrier or agent devices) or between nodes of computer system 1400. Network 1424 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1410 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output device(s) 1412 may, in some embodiments, include one or more display terminals, keyboards, keypads, touchpads, scanning devices, voice or optical recognition devices, or any other devices suitable for entering or accessing data by one or more computer systems 1400. Multiple input/output devices 1412 may be present in computer system 1400 or may be distributed on various nodes of computer system 1400. In some embodiments, similar input/output devices may be separate from computer system 1400 and may interact with one or more nodes of computer system 1400 through a wired or wireless connection, such as over network interface 1410.

Those skilled in the art will appreciate that computer system 1400 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 800 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter- computer communication. Some or all of the system components or data structures may also be stored (e.g., as instructions or structured data) on a computer-accessible medium or a portable article to be read by an appropriate drive, various examples of which are described above. In some embodiments, instructions stored on a computer- accessible medium separate from computer system 800 may be transmitted to computer system 800 via transmission media or signals such as electrical, electromagnetic, or digital signals, conveyed via a communication medium such as a network and/or a wireless link. Various embodiments may further include receiving, sending, or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD- ROM, volatile or non-volatile media such as RAM (e.g., SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A system, comprising:
a stator;
a rotor;
aperture blades arranged to form an aperture stop, wherein the aperture blades are coupled with the stator and the rotor, and wherein the aperture blades are movable to change a size of an aperture defined by the aperture stop;
an actuator for rotating the rotor, relative to the stator, about an axis that is parallel to an optical axis of a camera, wherein the actuator comprises one or more magnetic components fixedly coupled with the stator or the rotor; and
a locking mechanism comprising one or more metal plates fixedly coupled with the stator or the rotor, wherein the system is operable such that:
when no power is supplied to the actuator, an attractive force between the one or more magnetic components and the one or more metal plates is sufficient to maintain a predetermined aperture size by resisting rotation of the rotor, relative to the stator, about the axis; and
when a threshold amount of power is supplied to the actuator, a rotational force produced by the actuator is sufficient to overcome the attractive force between the one or more magnetic components and the one or more metal plates, so as to rotate the rotor, relative to the stator, about the axis, to change the aperture size.

2. The system of claim 1, wherein:
the actuator comprises a voice coil motor (VCM) actuator, and wherein the VCM actuator comprises:
one or more magnets comprising the one or more magnetic components; and
one or more coils positioned proximate the one or more magnets such that, when driven with an electric current, the one or more coils are capable of electromagnetically interacting with the one or more magnets to produce Lorentz forces that rotate the rotor about the axis parallel to the optical axis.

3. The system of claim 2, wherein:
the one or more magnets are fixedly coupled with the rotor;
the one or more coils are fixedly coupled with the stator; and
the one or more metal plates are fixedly coupled with the stator.

4. The system of claim 2, wherein:
the one or more magnets are fixedly coupled with the stator;
the one or more coils are fixedly coupled with the rotor; and
the one or more metal plates are fixedly coupled with the rotor.

5. The system of claim 2, wherein:
the stator comprises:
a base portion;
a central portion; and
an outer protrusion portion comprising protrusions that extend, in a first direction parallel to the optical axis, from the base portion, wherein the protrusions are distributed in a pattern that at least partially encircles the central portion; and
the rotor comprises a rotor wall that encircles the central portion of the stator, wherein the rotor wall is positioned, in a second direction orthogonal to the optical axis, between the central portion and the outer protrusion portion.

6. The system of claim 5, wherein:
the one or more magnets are fixedly coupled with the rotor wall;
the one or more coils are fixedly coupled with the outer protrusion portion of the stator; and
the one or more metal plates are fixedly coupled with the stator and positioned proximate the one or more magnets such that the one or more metal plates and the one or more magnets are capable of magnetically interacting with each other to produce the attractive force that is sufficient to maintain the predetermined aperture size when no power is supplied to the one or more coils.

7. The system of claim 1, further comprising:
a ball bearing suspension arrangement that suspends the rotor on the stator and that allows the rotor to rotate, relative to the stator, about the axis parallel to the optical axis, wherein the ball bearing suspension arrangement comprises one or more ball bearings disposed between the stator and the rotor.

8. A camera, comprising:
a lens group comprising one or more lens elements that define an optical axis; and
a variable aperture device, comprising:
a stator;
a rotor;
aperture blades arranged to form an aperture stop, wherein the aperture blades are coupled with the stator and the rotor, and wherein the aperture blades are movable to change a size of an aperture defined by the aperture stop;
an actuator for rotating the rotor, relative to the stator, about an axis that is parallel to the optical axis, wherein the actuator comprises one or more magnetic components fixedly coupled with the stator or the rotor; and
a locking mechanism comprising one or more metal plates fixedly coupled with the stator or the rotor, wherein the system is operable such that:
when no power is supplied to the actuator, an attractive force between the one or more magnetic components and the one or more metal plates is sufficient to maintain a predetermined aperture size by resisting rotation of the rotor, relative to the stator, about the axis; and
when a threshold amount of power is supplied to the actuator, a rotational force produced by the actuator is sufficient to overcome the attractive force between the one or more magnetic components and the one or more metal plates, so as to rotate the rotor, relative to the stator, about the axis, to change the aperture size.

9. The camera of claim 8, wherein:
the actuator comprises a voice coil motor (VCM) actuator, and wherein the VCM actuator comprises:
one or more magnets comprising the one or more magnetic components; and
one or more coils positioned proximate the one or more magnets such that, when driven with an electric current, the one or more coils are capable of electromagnetically interacting with the one or more magnets to produce Lorentz forces that rotate the rotor about the axis parallel to the optical axis.

10. The camera of claim 9, wherein:
the one or more magnets are fixedly coupled with the rotor;
the one or more coils are fixedly coupled with the stator; and
the one or more metal plates are fixedly coupled with the stator.

11. The camera of claim 9, wherein:
the one or more magnets are fixedly coupled with the stator;
the one or more coils are fixedly coupled with the rotor; and
the one or more metal plates are fixedly coupled with the rotor.

12. The camera of claim 9, wherein:
the stator comprises:
a base portion;
a central portion; and
an outer protrusion portion comprising protrusions that extend, in a first direction parallel to the optical axis, from the base portion, wherein the protrusions are distributed in a pattern that at least partially encircles the central portion; and
the rotor comprises a rotor wall that encircles the central portion of the stator, wherein the rotor wall is positioned, in a second direction orthogonal to the optical axis, between the central portion and the outer protrusion portion.

13. The camera of claim 12, wherein:
the one or more magnets are fixedly coupled with the rotor wall;
the one or more coils are fixedly coupled with the outer protrusion portion of the stator; and
the one or more metal plates are fixedly coupled with the stator and positioned proximate the one or more magnets such that the one or more metal plates and the one or more magnets are capable of magnetically interacting with each other to produce the attractive force that is sufficient to maintain the predetermined aperture size when no power is supplied to the one or more coils.

14. A device, comprising:
one or more processors;
memory storing program instructions executable by the one or more processors to control operations of a camera; and
the camera, comprising:
a lens group comprising one or more lens elements that define an optical axis; and
a variable aperture device, comprising:
a stator;
a rotor;
aperture blades arranged to form an aperture stop, wherein the aperture blades are coupled with the stator and the rotor, and wherein the aperture blades are movable to change a size of an aperture defined by the aperture stop;
an actuator for rotating the rotor, relative to the stator, about an axis that is parallel to the optical axis, wherein the actuator comprises one or more magnetic components fixedly coupled with the stator or the rotor; and
a locking mechanism comprising one or more metal plates fixedly coupled with the stator or the rotor, wherein the camera is operable such that:
when no power is supplied to the actuator, an attractive force between the one or more magnetic components and the one or more metal plates is sufficient to maintain a predetermined aperture size by resisting rotation of the rotor, relative to the stator, about the axis; and
when a threshold amount of power is supplied to the actuator, a rotational force produced by the actuator is sufficient to overcome the attractive force between the one or more magnetic components and the one or more metal plates, so as to rotate the rotor, relative to the stator, about the axis, to change the aperture size.

15. The device of claim 14, wherein:
the actuator comprises a voice coil motor (VCM) actuator, and wherein the VCM actuator comprises:
one or more magnets comprising the one or more magnetic components; and
one or more coils positioned proximate the one or more magnets such that, when driven with an electric current, the one or more coils are capable of electromagnetically interacting with the one or more magnets to produce Lorentz forces that rotate the rotor about the axis parallel to the optical axis.

16. The device of claim 15, wherein:
the one or more magnets are fixedly coupled with the rotor;
the one or more coils are fixedly coupled with the stator; and
the one or more metal plates are fixedly coupled with the stator.

17. The device of claim 15, wherein:
the one or more magnets are fixedly coupled with the stator;
the one or more coils are fixedly coupled with the rotor; and
the one or more metal plates are fixedly coupled with the rotor.

18. The device of claim 15, wherein:
the stator comprises:
a base portion;
a central portion; and
an outer protrusion portion comprising protrusions that extend, in a first direction parallel to the optical axis, from the base portion,
wherein the protrusions are distributed in a pattern that at least partially encircles the central portion; and
the rotor comprises a rotor wall that encircles the central portion of the stator, wherein the rotor wall is positioned, in a second direction orthogonal to the optical axis, between the central portion and the outer protrusion portion.

19. The device of claim 18, wherein:
the one or more magnets are fixedly coupled with the rotor wall;
the one or more coils are fixedly coupled with the outer protrusion portion of the stator; and
the one or more metal plates are fixedly coupled with the stator and positioned proximate the one or more magnets such that the one or more metal plates and the one or more magnets are capable of magnetically interacting with each other to produce the attractive force that is sufficient to maintain the predetermined aperture size when no power is supplied to the one or more coils.

20. The device of claim 14, wherein the one or more processors are configured to:
determine that the aperture size is being maintained, via the locking mechanism, at the predetermined aperture size;
determine control signals for changing the size of the aperture from the predetermined aperture size to a target size, wherein the control signals correspond to amounts of power that, when supplied to the actuator, cause the rotor to rotate, relative to the stator, to a target rotational position corresponding to the target size of the aperture, wherein the control signals comprise:
a first control signal corresponding to a first amount of power supplied during a first time period, wherein the first amount of power satisfies threshold amount of power sufficient to overcome the attractive force between the one or more magnetic components and the one or more metal plates; and
a second control signal corresponding to a second amount of power supplied during a second time period after the first time period, wherein the second amount of power is different than the first amount of power; and
transmit the control signals to change, using the actuator, the size of the aperture from the predetermined aperture size to the target size.
